(19) United States
(12) Patent Application Publication
(10) Pub. No.: US 2012/0066277 A1
(43) Pub. Date: Mar. 15, 2012

(54) FILE MANAGEMENT DEVICE

(76) Inventors: Hidenao UBUKATA, Kanagawa (JP); Takahiro YAMAMOTO, Kanagawa (JP); Hiroshi YAMAMOTO, Kanagawa (JP); Tomonori FUKUTA, Tokyo (JP); Yuichi INOUE, Kanagawa (JP); Tatsuo FUJIWARA, Tokyo (JP)

(21) Appl. No.: 13/232,725

(22) Filed: Sep. 14, 2011

(30) Foreign Application Priority Data
Sep. 14, 2010 (JP) 2010-205674

(51) Int. Cl. G06F 17/30

(52) U.S. Cl. 707/827; 707/E17.01

(57) ABSTRACT

A file management device manages a file on an online storage in a folder. The device includes a shared folder receiving unit to receive, form an information device used by a user having completed membership registration, designation of a shared folder to be shared with other users; a shared folder management information storage unit to generate shared folder management information in response to receipt of the designation of the shared folder and to store therein the shared folder management information so as to be associated with the designation of the shared folder; a folder share URL generation unit to generate a folder share uniform resource locator (URL) which includes the shared folder management information and is a URL of a Web site serving as an entry when accessing the shared folder; and a folder share URL notification unit to notify the information device of the folder share URL.

### CROSS-REFERENCE TO RELATED APPLICATIONS

The present application claims priority to and incorporates by reference the entire contents of Japanese Patent Application No. 2010-205674 filed in Japan on Sep. 14, 2010.

### BACKGROUND OF THE INVENTION

1. Field of the Invention

The present invention relates to a file management device that manages files on an online storage.

2. Description of the Related Art

With the spread of networks, an online storage service for managing files (computerized documents, images, and the like) acquired by an information device such as a personal computer (PC), a digital camera, or a mobile phone on a networked server has been widely used. In this service, a user having completed membership registration can operate an information device to access a networked server to thereby store files in an online storage area allocated to the user on an internal or external storage device of the server.

Moreover, a system is known in which when a user having completed membership registration to use an online service operates an information device to input e-mail addresses of users which are not members, human relationship, and the like to set an invitation, a server sends an invitation mail to the set e-mail addresses so that a user (invited person) which is not a member can share a file on an online storage (see Japanese Patent Application Laid-open No. 2008-197839).

However, in this system, since the user which has completed membership registration and has created an invitation needs to input e-mail addresses or the like of those who are invited and are not members, setting a number of invited persons takes a lot of time. Moreover, the user cannot invite persons whose e-mail addresses are unknown or who do not have an e-mail address.

### SUMMARY OF THE INVENTION

It is an object of the present invention to at least partially solve the problems in the conventional technology.

According to an aspect of the present invention, there is provided a file management device that manages a file on an online storage in a folder. The device includes a shared folder receiving unit configured to receive, form an information device used by a user having completed membership registration, designation of a shared folder to be shared with other users; a shared folder management information storage unit configured to generate shared folder management information in response to receipt of the designation of the shared folder and to store therein the shared folder management information so as to be associated with the designation of the shared folder; a folder share URL generation unit configured to generate a folder share uniform resource locator (URL) which includes the shared folder management information and is a URL of a Web site serving as an entry when accessing the shared folder; and a folder share URL notification unit configured to notify the information device of the folder share URL.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a file management system including a file management device of an embodiment of the invention;

FIG. 2 is a diagram illustrating the structure of a place management table stored in a database server in the file management system of the embodiment of the invention;

FIG. 3 is a diagram illustrating the content of a simple share information table stored in the database server in the file management system of the embodiment of the invention;

FIG. 4 is a flowchart of a process performed by an application server in the file management system of the embodiment of the invention when a user having completed membership registration executes a procedure of sharing a place with a user which is not a member;

FIG. 5 is a diagram illustrating a place setting screen displayed on an information device used by the user having completed membership registration during the process illustrated in FIG. 4;

FIG. 6 is a diagram illustrating a place setting complete screen displayed on the information device used by the user having completed membership registration during the process illustrated in FIG. 4;

FIG. 7 is a flowchart of a process performed by the application server in the file management system of the embodiment of the invention when other user performs a procedure of accessing a sharing file designated by the user having completed membership registration;

FIG. 8 is a diagram illustrating a simple share entry screen displayed on an information device used by other user during the process illustrated in FIG. 7;

FIG. 9 is a diagram illustrating a file list screen displayed on the information device used by other user during the process illustrated in FIG. 7; and

FIG. 10 is a diagram illustrating a file view screen displayed in response to a file select operation on the file list screen illustrated in FIG. 9.

### DETAILED DESCRIPTION OF THE PREFERRED EMBODIMENTS

Hereinafter, an embodiment of the invention will be described with reference to the drawings.

Configuration and Overall Operation of File Management System

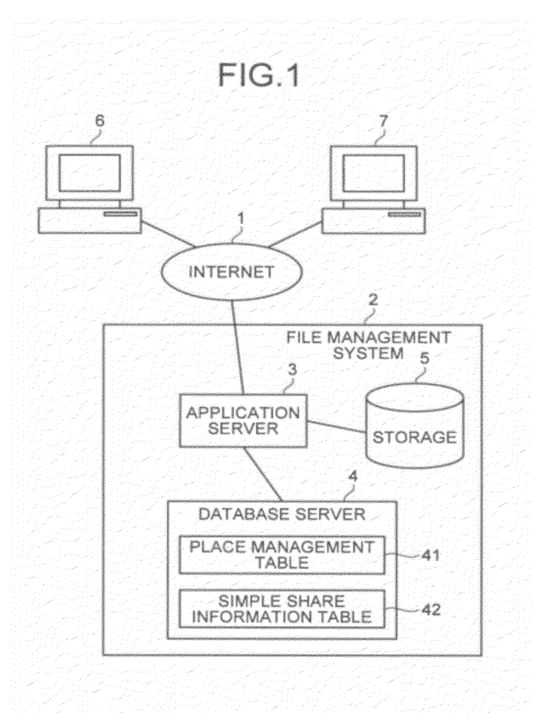

As shown in FIG. 1, a file management system 2 according to an embodiment of the invention is connected to information devices 6 and 7 such as a PC through the Internet 1. In this embodiment, it is assumed that the information device 6 is used by a user (hereinafter referred to as a “member user”) who has completed membership registration to use an online storage service provided by an application server of the file management system 2 and that the information device 7 is an information device used by other user. The information device 6 is used by the member user to share his/her own files on an online storage with other member users or users (hereinafter referred to as “non-member users”) which are not members.

The file management system 2 includes an application server 3 connected to the Internet 1, and a database server 4 and a storage 5 each connected to the application server 3. The application server 3 corresponds to the file management device of the present invention. In this embodiment, although the application server 3 is connected to the Internet 1, and the database server 4 and the storage 5 are connected to the application server 3, each may be connected to the Internet 1.

The application server 3 manages the storage 5 using a place management table 41 stored in the database server 4 and provides an online storage service to member users. That is, the application server 3 stores and manages a file such as an image file which is uploaded from the information device 6 in a storage area of the storage 5, which is allocated to each member user. Moreover, the application server 3 reads a requested file from the storage 5 in response to a download request from the information device 6 and sends the file to the information device 6.

Moreover, the application server 3 performs a simple share service in which a member user enables a non-member user to have limited access to a file using a simple share information table 42 stored in the database server 4. Details of the simple share service will be described later.

Management Information of Database Server

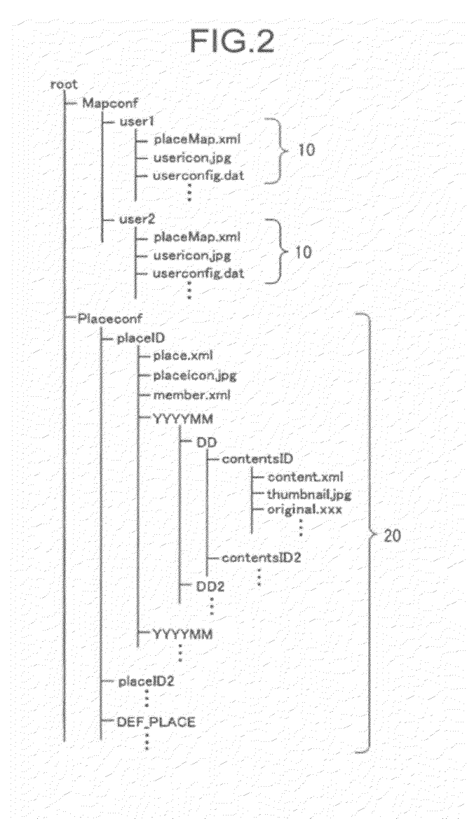

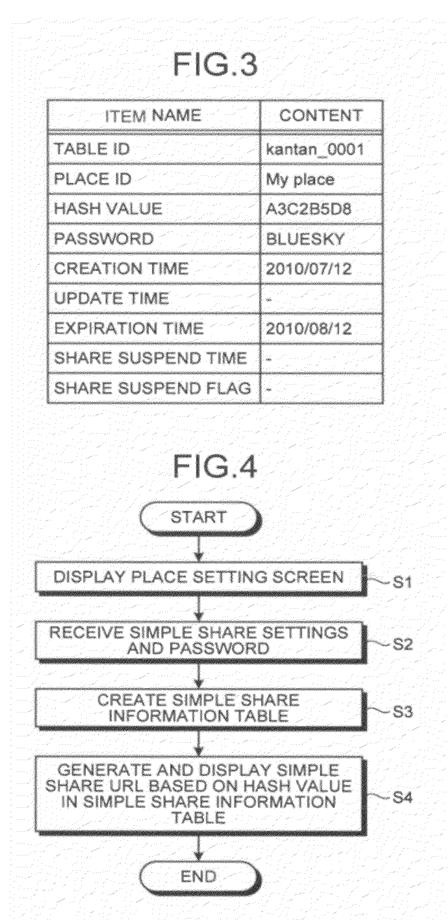

FIG. 2 is a diagram showing the structure of the place management table 41 stored in the database server 4, and FIG. 3 is a diagram showing the content of the simple share information table 42.

As shown in FIG. 2, the place management table 41 is made up of map management sections 10 that store therein setting information for displaying a place map screen on a display of the information device 6 and a place management section 20 that stores therein setting information of a region (place) on the place map screen. The place map screen is a screen in which symbol images representing file management units are arranged in a matrix form.

A Mapconf folder of the map management section 10 is a root folder of the map management section 10. The Mapconf folder includes user folders (user1, user2, and the like) prepared for each member user (for each user ID) who uses the system. In the user folder, the setting information (place map information: placeMap.xml) of a place screen for a user ID corresponding to a user folder name is stored. Moreover, “userconfig.dat” for recording information on a user such as an icon image (usericon.jpg) for the user ID, a user name or a contact address (for example, an e-mail address) corresponding to the user ID is also stored in the user folder.

Various types of setting information on the respective places are stored in the place management section 20. That is, a Placeconf folder of the place management section 20 is the root folder of the place management section 20. A placeID folder (placeID, placeID2, . . . ) and a DEF_PLACE folder are stored under the Placeconf folder. The placeID folder corresponds to file management information. The DEF_PLACE folder stores therein the setting information on a place in an unregistered state where a place attribute or a place name is not registered.

File registration information of a place (hereinafter, referred to as a corresponding place) corresponding to the placeID folder is stored under the placeID folder. In a place.xml (place information) of the file registration information, information on the corresponding place of the placeID folder that stores therein the place.xml is registered. Examples of the information include the place attribute which is an index for characterizing the place input from the user (the information device 6 of a client), a comment, and the like.

A YYYYMM folder is a folder representing the year and month when files are registered in the corresponding place. Here, “YYYY” represents year (western calendar year) and “MM” represents month. A DD folder representing the day when files are registered in the corresponding place is stored under the YYYYMM folder, which is generated whenever a file is registered. That is, the year, month, and day when a file is registered in a place can be checked from the data in the YYYYMM folder and the DD folder.

Under the DD folder, a contentsID folder corresponding to each of the files registered in the place is stored. Here, a file name (excluding an extension portion) of the file registered in the place is assigned to the folder name of the contentsID folder.

Under the contentsID folder, a content.xml which describes information on a file corresponding to the contentsID folder, a thumbnail.jpg which is the thumbnail image of the file, an original.jpg which is original data of the file, and the like are stored. Here, information on the file such as a storage location at which a file corresponding to the contentsID folder is actually stored, and a file attribute described later, registered in this file are described in the content.xml (file information).

As shown in FIG. 3, the simple share information table 42 includes a table ID, a place ID, a hash value, a password, a creation time, an update time, an expiration time, a share suspend time, and a share suspend flag.

The simple share information table 42 is created whenever a member user operates the information device 6 to executes an operation of sharing files in his/her own place managed by the place management table 41 with other users. As will be described later, since the sharing period is limited to a predetermined period (for example, one month), and sharing can be suspended during the period, the duration of the simple share information table 42 is within a predetermined period.

The table ID (in this example, kantan_0001) is the ID of the simple share information table 42. The place ID (in this example, My place) is the ID of a place that a member user shares with other users. The hash value (in this example, A3C2B5D8) is shared folder management information made up of a hash value generated from a hash function by the application server 3 in order to generate a simple share URL, namely the URL of a Web site which serves as an entry when other users access a place shared by the member user. Since the hash value is a random value, the shared folder management information is unique information capable of specifying the place ID stored in the simple share information table 42. The password (in this example, bluesky) is a word used for authentication when other users access a place shared by the member user.

The creation time (in this example, Dec. 7, 2010) is the date when the simple share information table 42 is created, and the update time is the data when the simple share information table 42 is updated. The expiration time (in this example, Dec. 8, 2010) is an expiration date of sharing the place, that is, after a lapse of a predetermined period (for example, one month) from the start of sharing which is the creation time. The share suspend time is the time when sharing is suspended within the expiration period after sharing starts, and the share suspend flag is an identification flag indicating the suspension of sharing. In this example, described is a case where the table is not updated and the sharing is not suspended, namely a case where no information is available for the update time, the sharing suspension time, and the sharing suspension flag.

Procedure of Sharing Place

FIG. 4 is a flowchart of a process performed by the application server 3 when a member user operates the information device 6 to execute a procedure of sharing a place with other users.

Through execution of the flow shown in FIG. 4, the simple share information table 42 shown in FIG. 3 is created. It is assumed that when the flow of FIG. 4 is executed, a place of the member user has been created on the storage 5, and a file has been registered in the place. Moreover, it is assumed that the member user has operated the information device 6 to start an application for receiving an online storage service, has entered a user ID or password to complete an authentication process, whereby a welcome screen of the online storage service has been displayed on the display of the information device 6.

The user of the information device 6 enters an instruction to execute a simple share service on the welcome screen of the online storage service, whereby the flow shown in FIG. 4 is started, and the application server 3 generates a place setting screen, transmits the place setting screen to the information device 6 and displays the place setting screen on the display of the information device 6 (step S1).

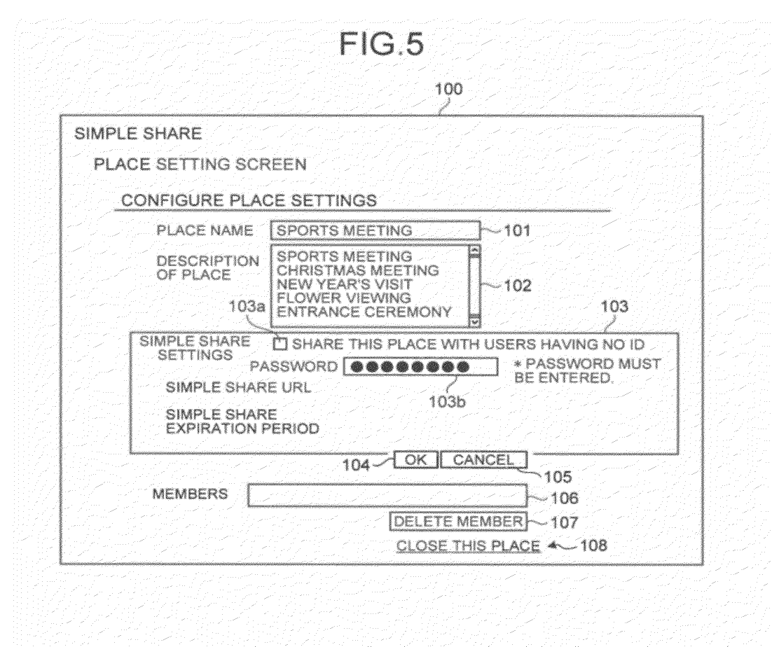

FIG. 5 shows an example of the place setting screen. In a place setting screen 100, a place name display region 101, a place description display region 102, a simple share setting region 103, an OK button 104, a cancel button 105, a member display region 106, a member delete button 107, a place closing instruction message display region 108, and the like are arranged.

In the place name display region 101, the name of a place that the member user shares with other users is displayed. In the place description display region 102, a list of place names that the member user has on the storage 5 is displayed, so that the member user can designate a desired place name within the list to thereby display the desired place name in the place name display region 101. In this example, the member user designates a place which stores a file related to a sports meeting, and as a result, “sports meeting” is displayed in the place name display region 101 as a place name.

In the simple share setting region 103, a check box 103a, a password input region 103b, and the like for configuring simple share settings are arranged. When the check box 103a is filled with a check mark, it is set such that a place displayed in the place name display region 101 is shared with non-member users. In the password input region 103b, black circles are displayed when the member user enters a password using the keyboard of the information device 6.

When the user presses the OK button 104 (for example, when confirmation is made by a mouse-click operation with a pointer or a cursor placed on the button) after a desired place name is displayed in the place name display region 101, the check box 103a is filled with a check mark, and a password is entered based on the instruction of the user of the information device 6, the application server 3 receives the simple share settings and the password (step S2) and creates the simple share information table 42 (step S3).

A plurality of places displayed in the place description display region 102 may be sequentially designated on the place setting screen 100, so that a plurality of places is shared. When the cancel button 105 is pressed, the contents of the place name display region 101, the place description display region 102, the check box 103a, and the password input region 103b are canceled. When a non-member user who uses the place is present, the name or the like of the non-member user is displayed in the member display region 106. The member delete button 107 is a button used when the member user deletes a non-member user displayed in the member display region 106. The place closing instruction message display region 108 is a region to be pressed by the member user to close (suspend the sharing of) the place.

In step S3, the application server 3 sets the table ID, the place ID, the hash value, the password, the creation time, and the expiration time among the items of the simple share information table 42.

An appropriate ID is determined for the table ID. As for the place ID, a place ID corresponding to the place name displayed in the place name display region 101 is acquired from the place management table 41. As for the hash value, fixed-length (for example, 16-digit) data is generated using a hash function. The password is a password that the user enters in the password input region 103b. As for the creation time, current time information of an internal clock is used. The expiration time is the date after a lapse of a predetermined period from the creation time.

Since the update time is set when the table is updated within an expiration period, the update time is not set in this example. The share suspend time and the share suspend flag are set when the user opens the place setting screen 100 within the expiration period and presses the place closing instruction message display region 108. In addition, when the users clears the check mark from the check box 103a of the simple share setting region 103, since sharing with only non-member users is suspended, the share suspend time and the share suspend flag are not written.

Subsequently, the application server 3 creates a simple share URL based on the hash value in the simple share information table 42, generates a place setting complete screen, transmits it to the information device 6, and causes the information device 6 to display it(step S4).

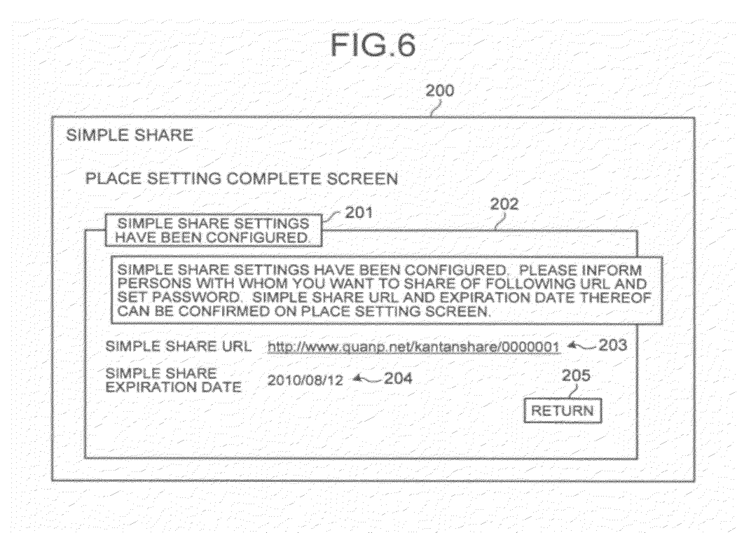

FIG. 6 shows an example of the place setting complete screen. In a place setting complete screen 200, a message 201 indicating that simple share settings have been configured, a prompt message 202 for informing persons with whom the user wants to share of a simple share URL and a password, a simple share URL 203, an expiration period 204, a return button 205, and the like are arranged. In FIG. 6, the last 7-digit numeric value within the simple share URL corresponds to the hash value.

The member user records the simple share URL by storing the place setting complete screen 200 or writing down the simple share URL. The simple share URL and the password can be notified to a desired person at a desired time. The means for notification may be any means such as an e-mail, a telephone, or handover of a memo. Thus, the member user does not need to input an e-mail address of a person with whom the user wants to share a place when configuring the simple share settings. Moreover, by informing persons whose e-mail addresses are unknown or who do not have an e-mail address, of the simple share URL, the member user can share the place with such persons. When the user presses the return button 205 on the place setting complete screen 200, the user can return to the place setting screen 100.

Procedure of Accessing Shared Place

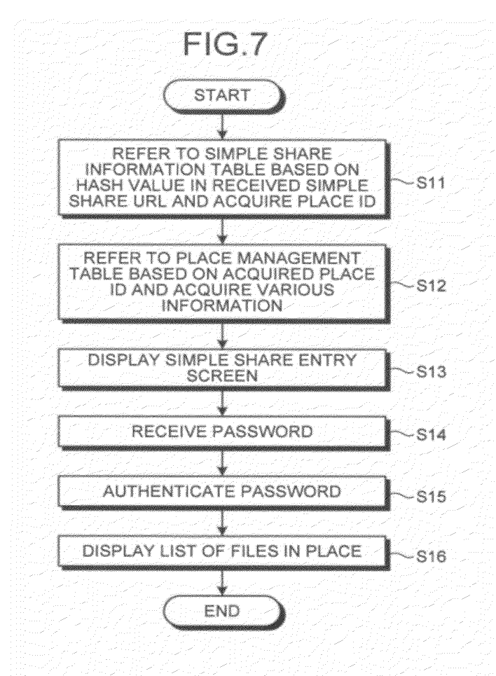

FIG. 7 is a flowchart of a performed by the application server 3 when another user executes a procedure of accessing a place shared by the member user. This flow is started when another user uses the information device 7 to input the simple share URL which is notified in advance to access the application server 3.

First, the application server 3 acquires a place ID by referring to the simple share information table 42 based on the hash value of the simple share URL received from the information device 7 (step S11).

Subsequently, the application server 3 acquires various types of information (for example, a place name, the number of files in the place, a content ID, and the like) of a place specified by the place ID by referring to the place management table 41 based on the acquired place ID and further acquires thumbnails of the files from the storage 5 based on the content ID (step S12).

Subsequently, the application server 3 generates and transmits a simple share entry screen to the information device 7 using the acquired various types of information, and causes the information device 7 to display the simple share entry screen on the display thereof (step S13).

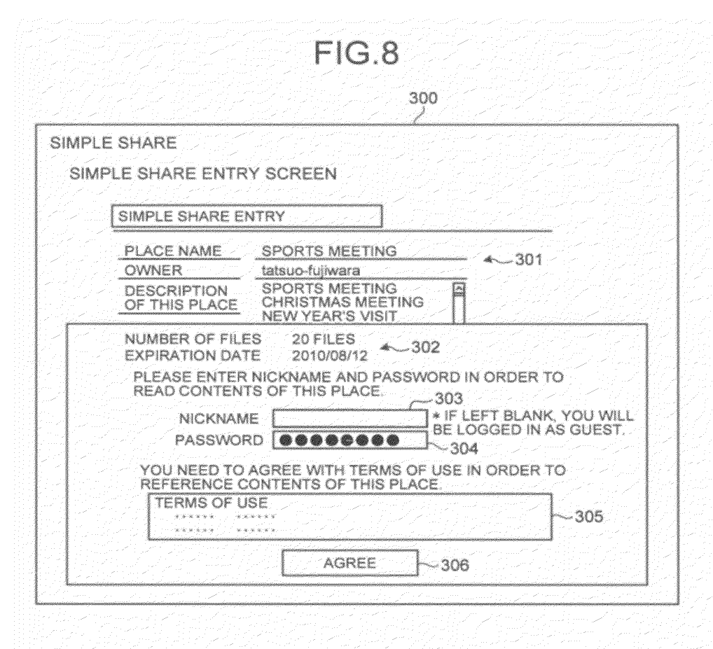

FIG. 8 shows an example of the simple share entry screen. In a simple share entry screen 300, a display region 301 for displaying a place name, an owner which is the name of a member user who shares the place, and the like, a display region 302 for displaying the number of files and the expiration date, a nickname input region 303, a password input region 304, a terms of use display region 305, an “Agree” button 306, and the like are arranged. The terms of use displayed in the terms of use display region 305 include the indication of functional restrictions, stating that the function of this simple share allow displaying and downloading of files, recording of comments, and the like, but editing, uploading of files and the like are not allowed.

When the user of the information device 7 enters a password and presses the “Agree” button 306, the password is transmitted to the application server 3. In this case, if a nickname is input, it is also transmitted.

The application server 3 receives the password (step S14) and performs authentication based on its matching with a password registered in the simple share information table 42 (step S15). Moreover, after the authentication, the application server 3 generates and transmits a file list screen to the information device 7 to be displayed on the display of the information device 7 (step S16). Moreover, when the nickname is input, and the nickname is registered in the simple share information table 42 as a member of the simple share. If the nickname is not input, “Guest” is registered as a member of the simple share. The member name is displayed in the member display region 106 of the place setting screen 100.

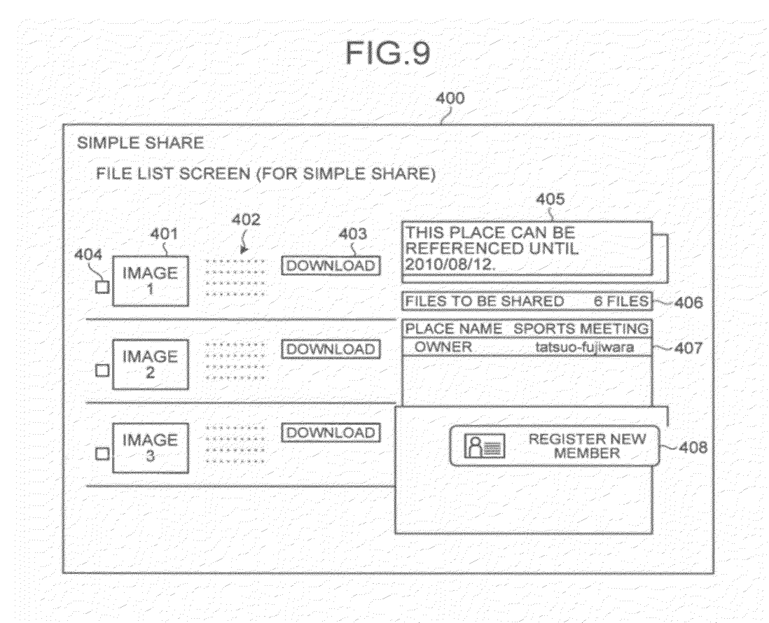

FIG. 9 shows an example of the file list screen. In a file list screen 400, thumbnails 401 of the respective files, file attribute information 402, download buttons 403, check boxes 404, a place expiration date message display region 405, a number-of-files display region 406 for displaying the number of files, a display region 407 for displaying a place name, an owner, and the like, a “register new member” button 408, and the like are arranged.

When the user fills the check box 404 with a check mark and presses the thumbnail 401, the screen changes to a file view screen and a file corresponding to the thumbnail 401 is displayed. When the user fills a check mark into the check box 404 and presses the download button 403, a file corresponding to the thumbnail 401 is downloaded. When the user presses the “register new member” button 408, a membership registration screen not shown is displayed.

In the place expiration date message display region 405, rather than displaying just the expiration date as shown in FIG. 9, a message prompting users to proceed to membership registration may be displayed, the message indicating the number of days left as the expiration date approaches, and the possibility to upload files and copy shared files if registered as a member. When the user of the information device 7 is a member user, a message may be displayed, stating that when a user ID is entered on the membership registration screen described above, the user is allowed to upload files and copy shared files.

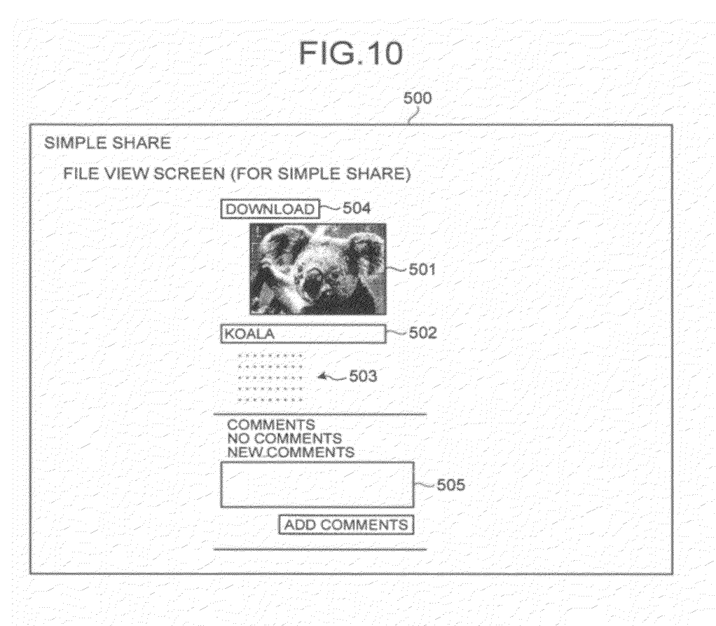

FIG. 10 shows an example of the file view screen. In a file view screen 500, a file display region 501, a file name display region 502, a file attribute information display region 503, a download button 504, a comment input region 505, and the like are arranged.

When the download button 504 is pressed, a file displayed in the file display region 501 is downloaded. The comments input in the comment input region 505 are stored in the place management table 41 so as to be associated with an input time and the name (a nickname or Guest) of a person who input the comments.

As described above, according to the file management system of the embodiment of the invention, when a member user selects a place to be shared and enters a password from the information device 6, the application server 3 generates and transmits a simple share URL for sharing the place to the information device 6. Thus, the user does not need to input an e-mail address of a person with whom the user wants to share the place when configuring the simple share settings. Moreover, the simple share URL and the password can be notified to a desired person at a desired time. Since the means for notification may be any means such as an e-mail, a telephone, or handover of a memo, the user can share the place with persons whose e-mail addresses are unknown or who do not have an -mail address.

According to the invention, when a user having completed membership registration designates a sharing folder, the file management device generates and stores shared folder management information so to be associated with the designated folder, generates a folder share URL which includes the shared folder management information and which is a URL of a Web site serving as an entry when accessing the designated shared folder, and issues the folder share URL to the user who designated the folder. The user having designated the folder notifies other users of the issued file share URL at a desired time using optional means.

According to the invention, when a user having completed membership registration to use an online storage service shares files on an online storage with other users, the user does not need to perform an operation of inputting e-mail addresses of other users. Moreover, the user can share the files with persons whose e-mail addresses are unknown or who do not have an e-mail address.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A file management device that manages a file on an online storage in a folder, comprising:
a shared folder receiving unit configured to receive, form an information device used by a user having completed membership registration, designation of a shared folder to be shared with other users;
a shared folder management information storage unit configured to generate shared folder management information in response to receipt of the designation of the shared folder and to store therein the shared folder management information so as to be associated with the designation of the shared folder;
a folder share URL generation unit configured to generate a folder share uniform resource locator (URL) which includes the shared folder management information and is a URL of a Web site serving as an entry when accessing the shared folder; and
a folder share URL notification unit configured to notify the information device of the folder share URL.

2. The file management device according to claim 1,
wherein the shared folder management information includes a hash value.

3. The file management device according to claim 1, further comprising:
a shared folder management information acquisition unit configured to acquire shared folder management information based on a folder share URL which is input from an information device used by the other user;
a shared folder specifying unit configured to specify a shared folder based on the shared folder management information acquired by the shared folder management information acquisition unit; and
a shared file transmission unit configured to transmit a file in the shared folder specified by the shared folder specifying unit to the information device used by the other user.

4. The file management device according to claim 1, further comprising a unit configured to set a storage period in the shared folder management information storage unit.

5. The file management device according to claim 3, further comprising:
a password storage unit configured to store therein a password input from the information device used by the user having completed the membership registration; and
an authenticating unit configured to perform authentication based on whether a password input from the information device used by the other user matches the password stored in the password storage unit,
wherein the shared file transmission unit transmits a file only when the authentication by the authenticating unit is successful.
